(19) United States
(12) Patent Application Publication
(10) Pub. No.: US 2007/0143507 A1
(43) Pub. Date: Jun. 21, 2007

(54) Storage device with mobile source module

(75) Inventors: Shih-Hui Chen, Taoyuan Hsieh (TW); Chin-Tien Lin, Taoyuan Hsieh (TW)

Correspondence Address: TROXELL LAW OFFICE PLLC, SUITE 1404, 5205 LEESBURG PIKE, FALLS CHURCH, VA, 22041, US

(73) Assignee: Tennrich International Corp.

(21) Appl. No.: 11/304,753

(22) Filed: Dec. 16, 2005

(51) Int. Cl. G06F 13/12

(52) U.S. Cl. 710/74

(57) ABSTRACT

A storage device comprised of process unit, memory unit and charging unit contains a built-in mobile source module; the source module being charged by a source externally connected to a data process device when the latter is connected to the storage device via a first communication interface; alternatively a second communication interface being disposed to the storage device to connect other electronic device to be charged by the source module via the second communication interface or directly supplied with the power from the source module in the storage device.

### BACKGROUND OF THE INVENTION

(a) Field of the Invention

The present invention is related to an improved construction of a storage device, and more particularly, to one provided with a built-in mobile source module to allow charging/discharging while in use.

(b) Description of the Prior Art

Newer computer-based products are introduced into the market at an astonishing speed to expand the application aspects of the computer thanks to advanced technology. For example, the capacity of a hard disk has been upgraded from its initial 10 MB to 80 GB or even higher achieving a growth rate over 8,000 folds. Accordingly, more massive and refined digital data can be stored. Meanwhile, other digital products emphasizing portability such as a notebook, Personal Digital Assistant (PDA), flash disk, MP3 or digital camera is capable of processing data and storing the same in the form of digital electronic file for longer preservation, repeated read-out, or storage in a hard disk of the computer.

Data storage devices generally available in the market can be roughly classified into two types. The first type relates to electronic solid-status memory device such as an Read Only Memory (ROM) or Random Access Memory (RAM) usually embedded in the PDA, flash disk or MP3 while serving as a mobile storage device. For example, the flash disk uses Universal Serial Bus (USB) interface as a communication interface to connect to a computer for storing data in the memory of the flash disk into the computer.

The second type of storage device relates to one that is surface mounted such as a memory card to be inserted into a digital camera to store digital image data. The memory card is allowed to transmit the data stored in the memory card to a computer via a communication interface (e.g., a card reader).

Either type has been popularly applied in our daily life. How to develop many additional functions for the storage device other than storage and transmission functions has been the topic many IT industries are working hard to explore.

### SUMMARY OF THE INVENTION

The primary purpose of the present invention is to provide a storage device adapted with a mobile source module. The storage device contains process unit, memory unit, and charging unit. Furthermore, a first communication interface is disposed at where appropriately to connect the storage device to a data process device. The storage device has the built in mobile source module so that when the storage device is connected to a data process device, the source module is charged by an external source connected to the data process device for the source module to maintain a certain level of power at any time.

Alternatively, a second communication interface is connected to another electronic device so that when the storage device is in operation, the source module charges the electronic device via the second communication interface, or directly supplies power to the electronic device.

### BRIEF DESCRIPTION OF THE DRAWINGS

FIG. 1 is a schematic view showing a first preferred embodiment of the present invention in its operating status.

FIG. 2 is a schematic view showing an internal construction of the first preferred embodiment of the present invention.

FIG. 3 is a perspective view of the construction of the first preferred embodiment of the present invention.

FIG. 4 is a schematic view showing a second preferred embodiment of the present invention in its operating status.

FIG. 5 is a schematic view showing an internal construction of a third preferred embodiment of the present invention.

FIG. 6 is a schematic view showing the third preferred embodiment of the present invention in its operating status.

FIG. 7 is a schematic view showing a fourth preferred embodiment of the present invention in its operating status.

### DETAILED DESCRIPTION OF THE PREFERRED EMBODIMENTS

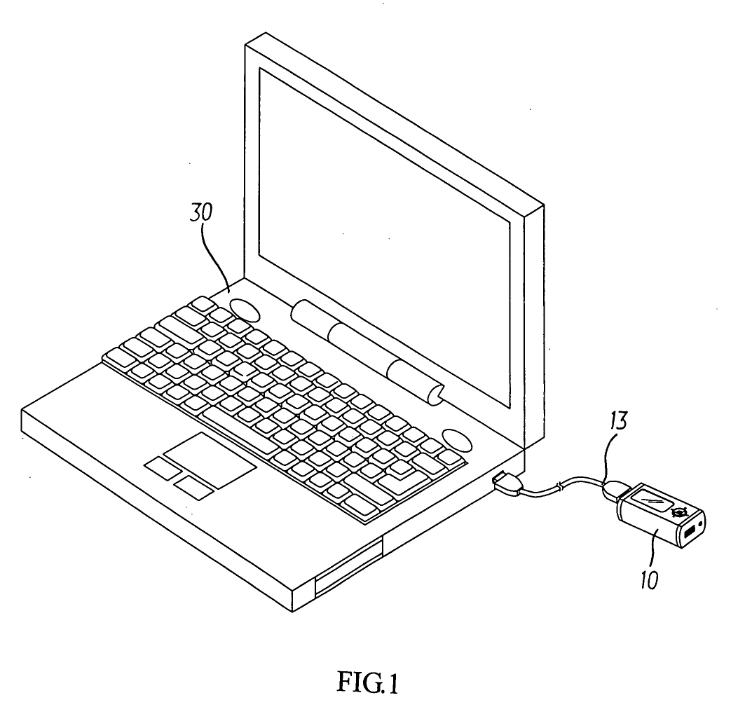

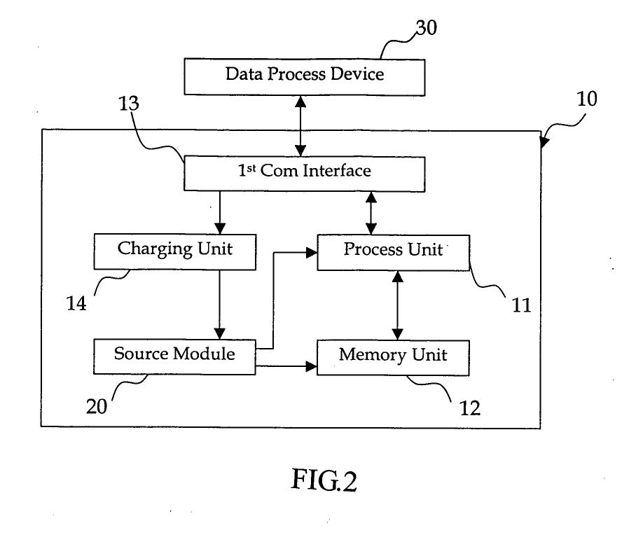

Referring to FIGS. 1 and 2 for a first preferred embodiment of the present invention, a storage device 10 contains a process unit 11 to register data into a memory unit 12. A first communication interface 13 related to an IEEE1394 (Institute of Electrical and Electronics 1394) or a USB is disposed to the front end of the storage device 10 to connect the storage device 10 to a data process device 30 via the first communication interface 13. The storage device 10 is related to a flash disk as illustrated in FIG. 1, PDA, MP3, pen driver, or digital camera; and the data process device is related to a PC (personal computer) or a portable computer. When the storage device 10 is connected to the data process device 30, data from the storage device 10 are transmitted via the first communication interface 13 to the data process device for shared data. A memory card related to an MS (Memory Stick), CF (Compact Flash), SMC (Smart Media), MMC (Multi Media), SD (Secure Digital) or XD (XD-Picture Card) is further included in the data process unit 11 of the storage device 10 to expand its memory capacity.

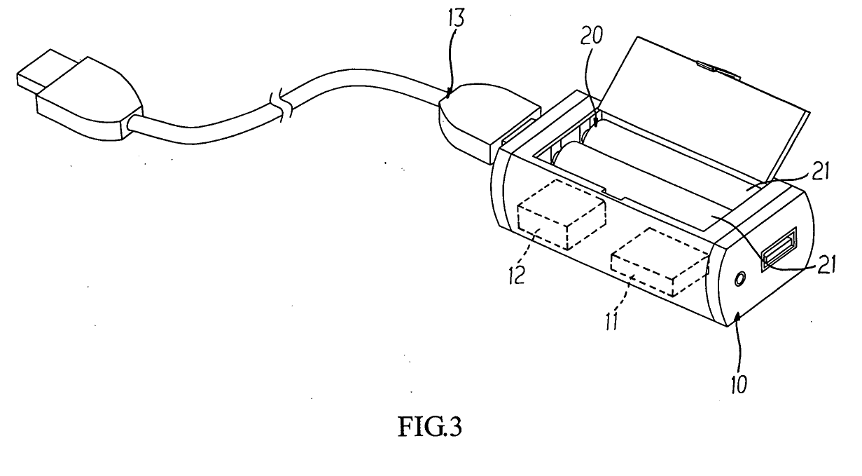

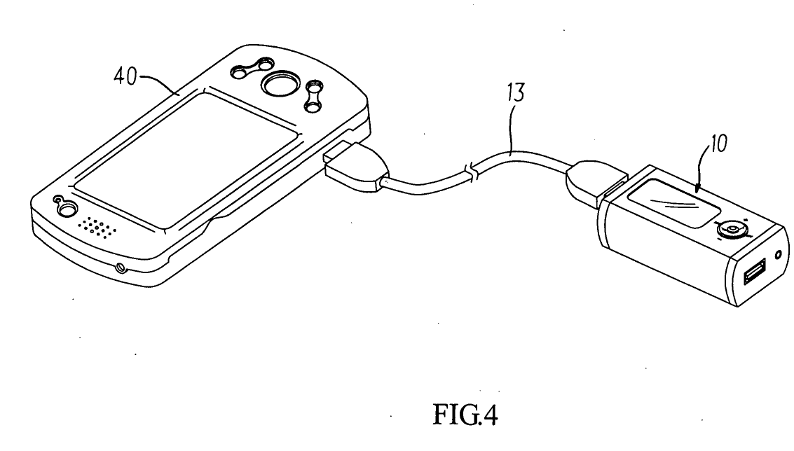

The storage device 10 contains further a charging unit 14 and a source module 20 as illustrated in FIG. 3. Wherein, the source module is comprised of multiple rechargeable cells 21. The source module 20 may has its power supplied by an externally connected device to drive the process unit 11 while the charging unit 14 charges those multiple rechargeable cells 21. Accordingly, when the storage device 10 is connected to the data process device 30 via the first communication interface 13, the source from the data process device 30 charges the source module 20 built in the storage device at the same time as illustrated in FIGS. 1 and 2 to give the source module 20 a certain level of power and becomes a mobile source module for the first communication interface 13 to charge another electronic device 40 e.g., a handset or PDA. The first communication interface relates to an IEEE1394 or a USB. In the preferred embodiment of the present invention as illustrated in FIG. 4, both ends of a connection cable are respectively disposed with a USB or those multiple rechargeable cells 21 in the source module 20 can be forthwith removed for use.

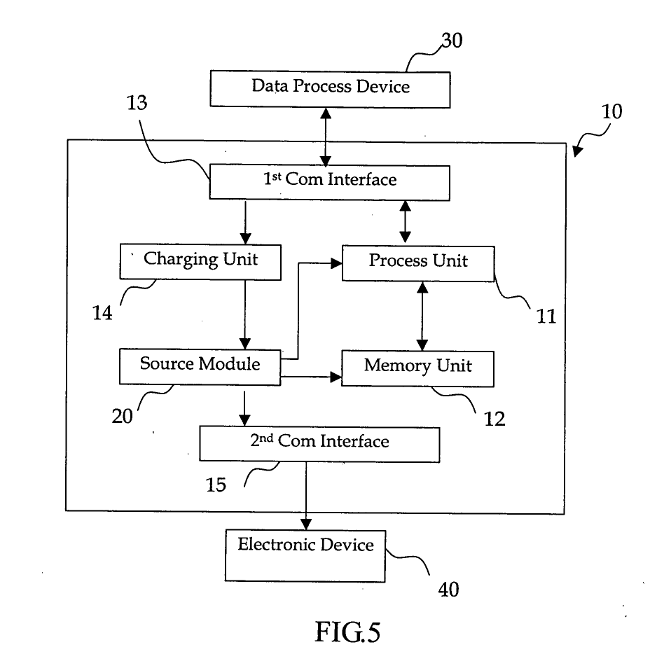

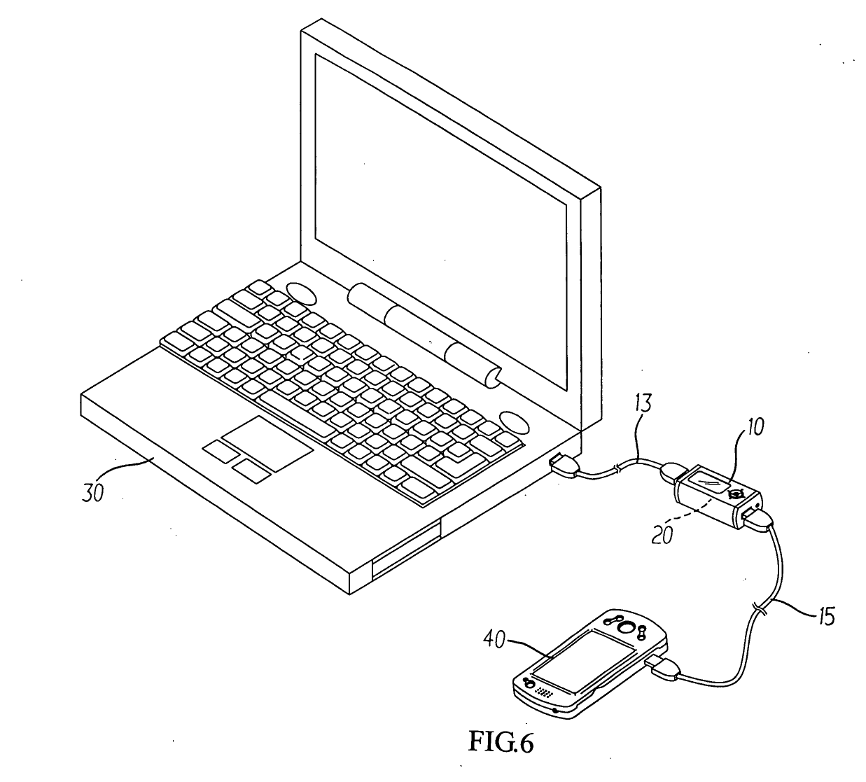

Now referring to FIGS. 5 and 6 for a second preferred embodiment of the present invention, the storage device 10 contains the source module and a second communication interface 15 related to an IEEE1394 or USB is disposed at where appropriately. Wherein, both ends of a connection cable are also respectively disposed with a USB. Accordingly, when the storage device 10 is connected to the data process device 30 via the first communication interface 13, the source module 20 in the storage device 10 charges the electronic device 40 (e.g., a handset or PDA) via the second communication interface 15.

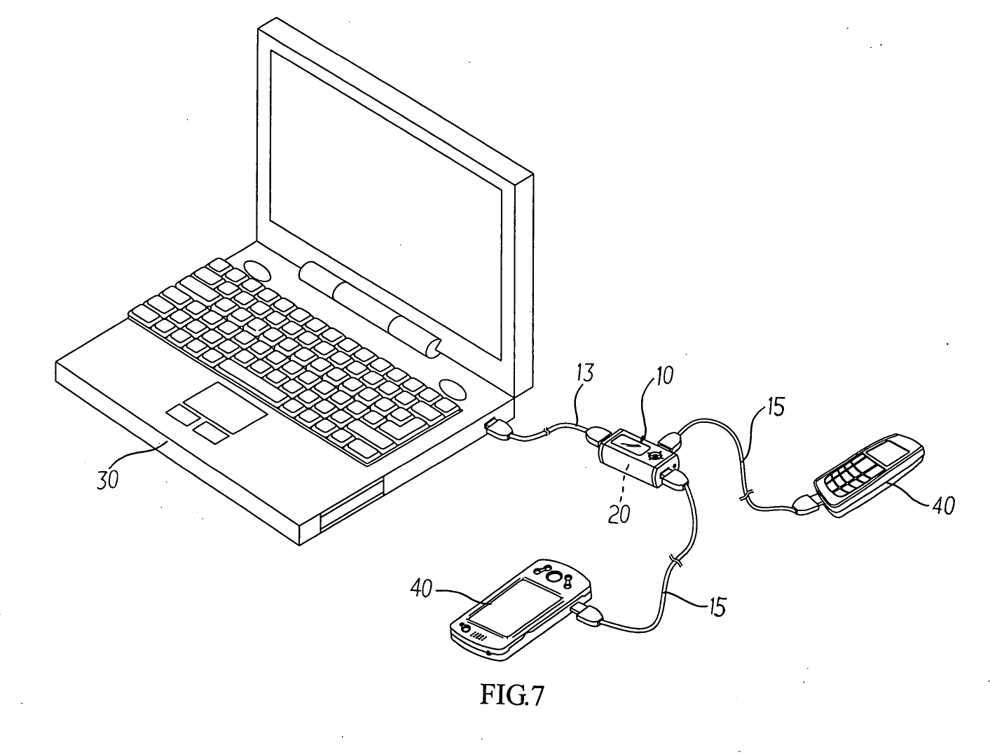

The second communication interface may be disposed at where appropriately to the storage device. In the preferred embodiment, the second communication interface is provided on one side of the storage device 10 through a USB. Multiple second communication interfaces 15 may be provided as illustrated in FIG. 7 to charge multiple units of the electronic device 40.

The prevent invention provides an improved construction of a storage device containing a built-in mobile source module to charge/discharge while the storage device is in use, and the application for a utility patent is duly filed accordingly. However, it is to be noted that the preferred embodiments disclosed in the specification and the accompanying drawings are not limiting the present invention; and that any construction, installation, or characteristics that is same or similar to that of the present invention should fall within the scope of the purposes and claims of the present invention.

I claim:

1. A storage device containing a mobile source module includes a process unit, a memory unit, a charging unit, and a first communication interface; the source module built-in the storage device and with its circuit connected to the charging unit and the process unit to exercise charging/discharging; and the first communication interface connecting the storage device to one end of a data process device.

2. The storage device containing a mobile source module of claim 1, wherein a second communication interface is further disposed to the storage device.

3. The storage device containing a mobile source module of claim 1, wherein each of the first and the second communication interfaces relates to an IEEE1394 or a USB.

4. The storage device containing a mobile source module of claim 2, wherein each of the first and the second communication interfaces relates to an IEEE1394 or a USB.

5. A storage device containing a mobile source module includes a process unit, a memory unit, a charging unit, and a first communication interface; the source module built-in the storage device and with its circuit connected to the charging unit and the process unit to exercise charging/discharging; the first communication interface connecting the storage device to one end of a data process device; a second communication interface connecting the storage device to another electronic device; and the source module charging the electronic device while the storage device is in operation.

6. The storage device containing a mobile source module of claim 5, wherein each of the first and the second communication interfaces relates to an IEEE1394 or a USB.

7. The storage device containing a mobile source module of claim 1, wherein the storage device is related to a flash disk, PDA, MP3, pen driver, or a digital camera.

8. The storage device containing a mobile source module of claim 5, wherein the storage device is related to a flash disk, PDA, MP3, pen driver, or a digital camera.

9. The storage device containing a mobile source module of claim 1, wherein the data process device is related to a PC or a portable computer.

10. The storage device containing a mobile source module of claim 5, wherein the data process device is related to a PC or a portable computer.

11. The storage device containing a mobile source module of claim 1, wherein the memory unit relates to a memory card in a Flash Memory, MS (memory stick), CF (compact flash), SMC (smart media), MMC (multi media), SD (Secure Digital), or XD (XD-Picture Card).

12. The storage device containing a mobile source module of claim 5, wherein the memory unit relates to a memory card in a Flash Memory, MS (memory stick), CF (compact flash), SMC (smart media), MMC (multi media), SD (Secure Digital), or XD (XD-Picture Card).

13. The storage device containing a mobile source module of claim 1, wherein the source module contains multiple rechargeable cells.

14. The storage device containing a mobile source module of claim 5, wherein the source module contains multiple rechargeable cells.
